(19) United States
(12) Patent Application Publication
(10) Pub. No.: US 2002/0125784 A1
(43) Pub. Date: Sep. 12, 2002

(54) Reduced magnetic noise and current ripple automotive alternator

(76) Inventors: Eric D. Bramson, Ann Arbor, MI (US); Kirk E. Neet, Saline, MI (US)

Correspondence Address: Kevin G. Mierzwa, Artz & Artz, PC, 28333 Telegraph Road Suite 250, Southfield, MI, 48034, US

(21) Appl. No.: 09/802,142

(22) Filed: Mar. 8, 2001

(51) Int. Cl. H02K 3/00

(52) U.S. Cl. 310/184

(57) ABSTRACT

An electrical machine (20) includes a stator core (54) having slots (80) and a set of windings (58) disposed within the slots (80). The windings (58) are configured in 2N+1 phases, where N in greater than 1. Such a machine is particularly useful for automotive alternators.

The present invention relates generally to rotating electrical machines, and more particularly, to a stator structure configured to generate a reduced amount of audible noise.

### TECHNICAL FIELD

Alternators are rotating electrical machines used in vehicles for generating electric power to charge the battery when the rotor of the alternator is turning at a sufficient speed. Those skilled in the art will recognize that alternators are also referred to as generators. In the design of automotive vehicles, manufacturers are continually trying to reduce the audible noise generated from various components in the vehicle. Alternators generate audible noise due to the magnetic forces in the alternator and other factors, such as fan noise.

Current ripple in the output is also undesirable. Current ripple occurs when the AC output of the alternator is rectified. The rectification is a summation of the output currents from the various phases of the machine. The DC current therefore has some fluctuation. Three phase alternators are common. In a three phase alternator, six crests and valleys occur over one electrical cycle which is defined as the rotor rotation through one pair of magnetic poles. Current ripple has also been found to contribute to audible noise. When the current at the output has ripple, the input torque also ripples. The input torque ripples in response to maintaining a relatively constant speed in the rotating machine. This phenomenon causes audible noise as well.

Therefore, it would be desirable to provide an alternator stator configuration that reduces current ripple and thus, audible noise.

### SUMMARY OF THE INVENTION

The reduced oscillation of magnetic flux of the present invention provides an alternator with reduced noise and smoother output.

In one aspect of the invention, an electrical machine includes a stator core having slots and a set of windings disposed within the slots. The windings are configured in 2N+1 phases, where N is an integer greater than 1. Such a machine is particularly useful for automotive alternators.

One advantage of the invention is that because a smoother output signal is produced, lower electromagnetic interference is generated.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a cross-sectional view of an electrical machine incorporating the present invention.

FIG. 2 is a partial cut-away perspective view of a stator core according to a seven phase (N=3) implementation of the present invention.

FIG. 3 is a plan view of a stator core according to the present invention.

FIG. 4 is a schematic view of a first embodiment of a winding circuit according to the present invention.

FIG. 5 is a schematic view of a second embodiment of a winding circuit according to the present invention.

FIG. 6 is a current versus time plot of a three phase alternator of the prior art.

FIG. 7 is a current versus time plot of a seven phase (N=3) alternator according to the present invention.

FIG. 8 is a plot of noise versus speed of a winding according to the present invention compared to existing windings.

### DETAILED DESCRIPTION OF THE PREFERRED EMBODIMENT

In the following figures, the same reference numerals will be used to identity the same components in the various views. Although one embodiment of an alternator is illustrated, the stator winding circuit embodiments described below may be used in a variety of types of rotating electrical machines including liquid-cooled alternators, air-cooled alternators and various configurations of alternators including multiple rotor alternators and the like.

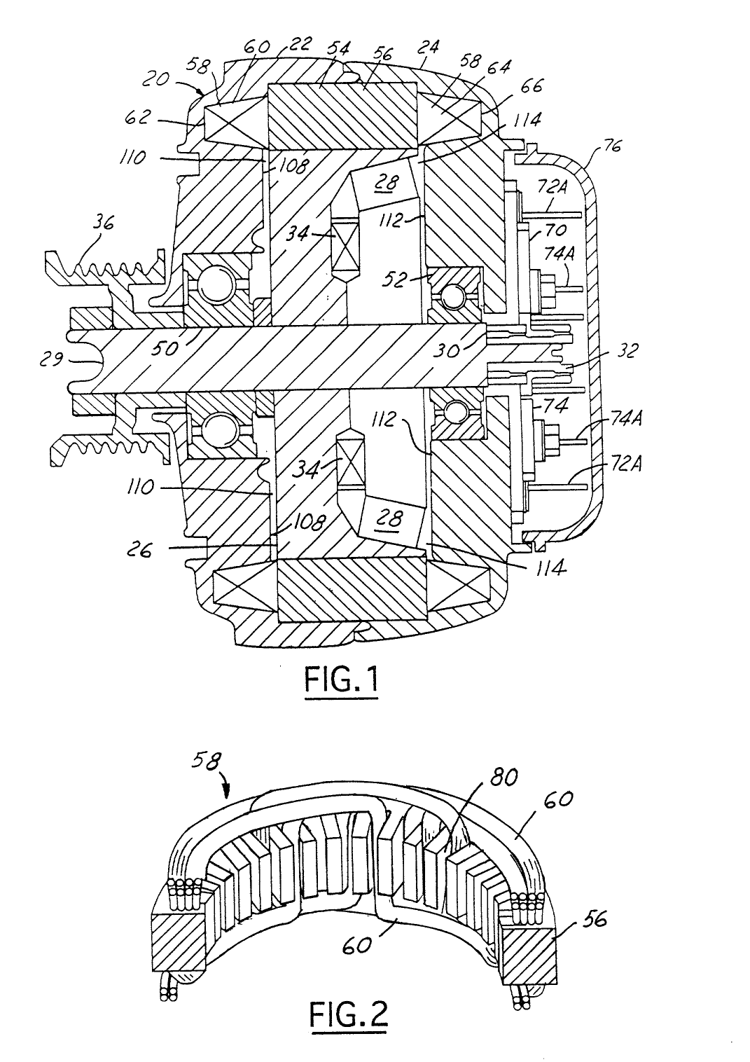

Referring now to FIG. 1, an alternator 20 includes a front housing portion 22 and a rear housing portion 24 which are suitably bolted or otherwise attached together. Front housing portion 22 and rear housing portion 24 are preferably metallic. The housing portions 22 and 24 may be configured with openings for air cooling or fluid passages for liquid cooling as is known to those skilled in the art. A rotor 26 is included within front housing portion 22 and rear housing portion 24. Those skilled in the art will recognize rotor 26 as being generally of the “claw-pole” variety. A plurality of permanent magnets 28 may be disposed within rotor 26 in order to enhance the electrical output of alternator 20.

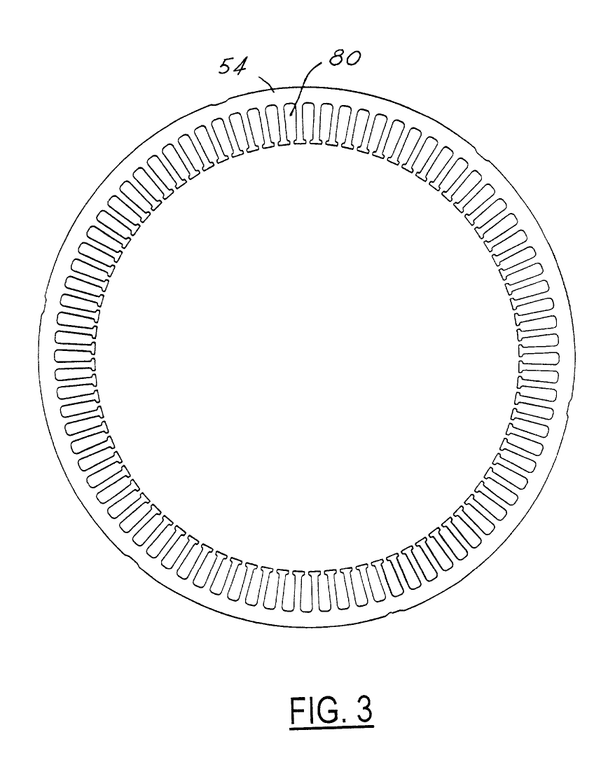

Rotor 26 includes a shaft 29 having two slip rings 30 and 32 which are means for providing electrical power from a voltage regulator (not shown in the particular sectioning employed in FIG. 3) to a field coil 34 disposed within rotor 26. Also coupled to shaft 29 is a pulley 36, or other means for rotating rotor 26. Shaft 29 is rotatably supported by a front bearing 50, itself supported by front housing portion 22, and a rear bearing 52, supported by rear housing portion 24.

A stator 54 is disposed in opposition to rotor 26. Stator 54 includes a ferromagnetic stator core 56, on which stator windings 58 are wound.

A rectifier 70, coupled to stator windings 58 in order to rectify the alternating current output generated in stator windings 58 by the operation of alternator 20, is mounted to rear housing 24. Rectifier 70 is formed of many rectifying elements which are preferably diodes. However, other rectifying elements such as transistors may also be used. Rectifier 70 includes a negative rectifier plate 72, which forms the common connection for the cathodes of the “negative” diodes 72A. Rectifier 70 also includes a positive rectifier plate 74, which forms the common connection for the anodes of the “positive” diodes 74A. Negative rectifier plate 72 and positive rectifier plate 74 are electrically insulated from one another. A plastic cover 76 covers the rear of alternator 20, including rectifier 70. Electrical connectors 77 and 78 provide the required electrical connections to and from alternator 20. As those connections are conventional, they are not described in detail here.

Referring now to FIGS. 2 and 3, a respective partial cutaway perspective view of a stator 54 is illustrated. Windings 58 with end turns 60 extending therefrom are positioned within slots 80 of stator core 56 in a conventional manner. In the illustrated embodiment 84 slots 80 were used. Preferably, full pitch windings are used, i.e., opposite poles are 180° apart electrically. However, fractional pitches less than 180° may also be used.

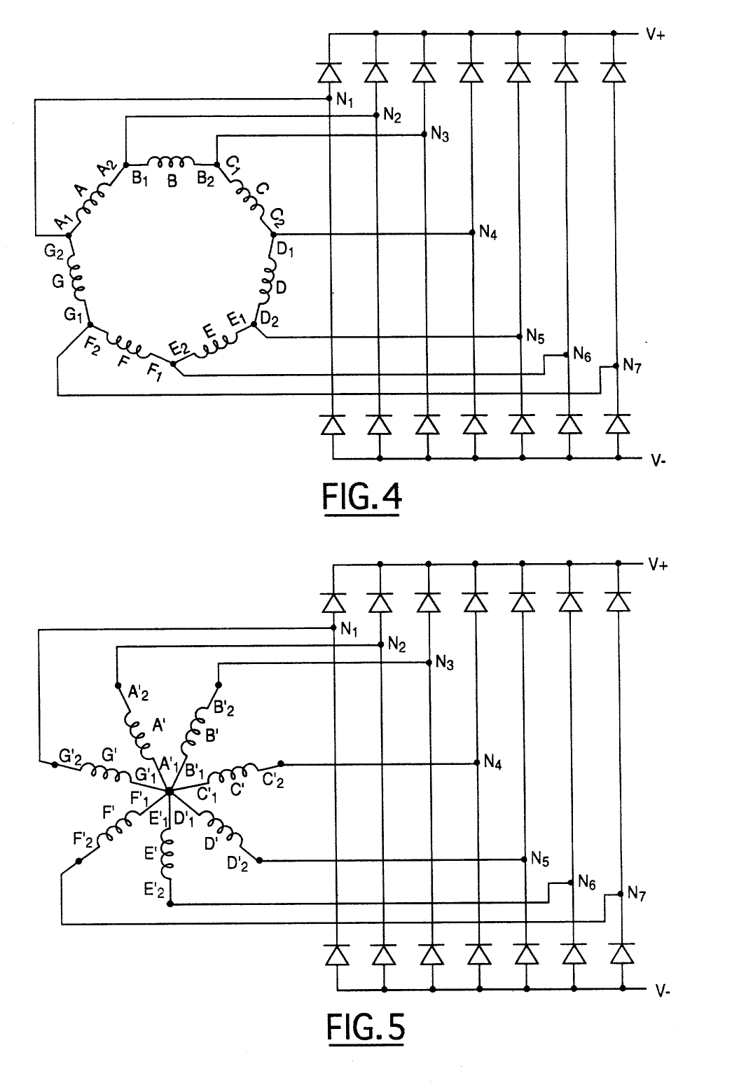

Referring now to FIG. 4, a schematic view of a first embodiment of a stator circuit 300 is coupled to a rectifier circuit 302. Stator circuit 300 has 2N+1 phases or windings. In the following examples, N=3 and therefore there are seven windings. The present invention applies equally to other circuits where N is an integer greater than one. Prior art systems typically use N=1 as in a three phase implementation. In this example, windings A, B, C, D, E, F and G are coupled schematically in a polygon. That is, each end of each of windings A-G is coupled to one end of another one of the windings. As illustrated, winding end A₁, is coupled to winding end G₂, winding end A₂ is coupled to winding end B₁, winding end B₂ is coupled to winding end C₁, winding end C₂ is coupled to winding end D₁, winding end D₂ is coupled to winding end E₁, winding end E₂ is coupled to winding end F₁, and winding end F₂ is coupled to winding end G₁.

Rectifier circuit 302 is a common type full wave rectifier circuit as it would be evident to those skilled in the art which has been expanded to accommodate the number of phases of the electrical machine. That is, preferably one pair of diodes is provided for each phase and therefore the number of diodes equals 2(2N+1) or 14 for the case where N=3. Those skilled in the art will, however, appreciate that a greater number of diodes may be used. Rectifier circuit 302, as illustrated has fourteen diodes 304-317. Each diode has an anode and a cathode. The cathodes of diodes 305, 307, 309, 311, 313, 315 and 317 are coupled together. The anodes of cathodes 304, 306, 308, 310, 312, 314 and 316 are coupled together. The cathode of diode 304 is coupled to the anode of diode 305. The cathode of diode 306 is coupled to the anode of diode 307. The cathode of diode 308 is coupled to the anode of diode 309. The cathode of diode 310 is coupled to the anode of diode 311. The cathode of diode 312 is coupled to the anode of diode 313. The cathode of diode 314 is coupled to the anode of diode 315. The cathode of diode 316 is coupled to the anode of diode 317. The nodes (N1-N7) between respective diode pairs 304 and 305, 306 and 307, 308 and 309, 310 and 311, 312 and 313, 314 and 315, and 316 and 317 receive the output from one of the winding intersections (e.g., A2:B1, B2:C1).

Referring now to FIG. 5, a modified winding circuit 300′ is illustrated. In this embodiment, the phases A-G are coupled in a star configuration to a common node N₈. That is, winding ends A₁′-G₁′ are coupled to common node N₈.

Rectifier circuit 302 is configured identically to that shown in FIG. 4 except for the location from where they are coupled to stator circuit 300′. Each phase has one end coupled to stator circuit 302. That is, winding end A₂′, B₂′ . . . , G₂′ are coupled to nodes N₁-N₇. Optional diodes may be included at N8.

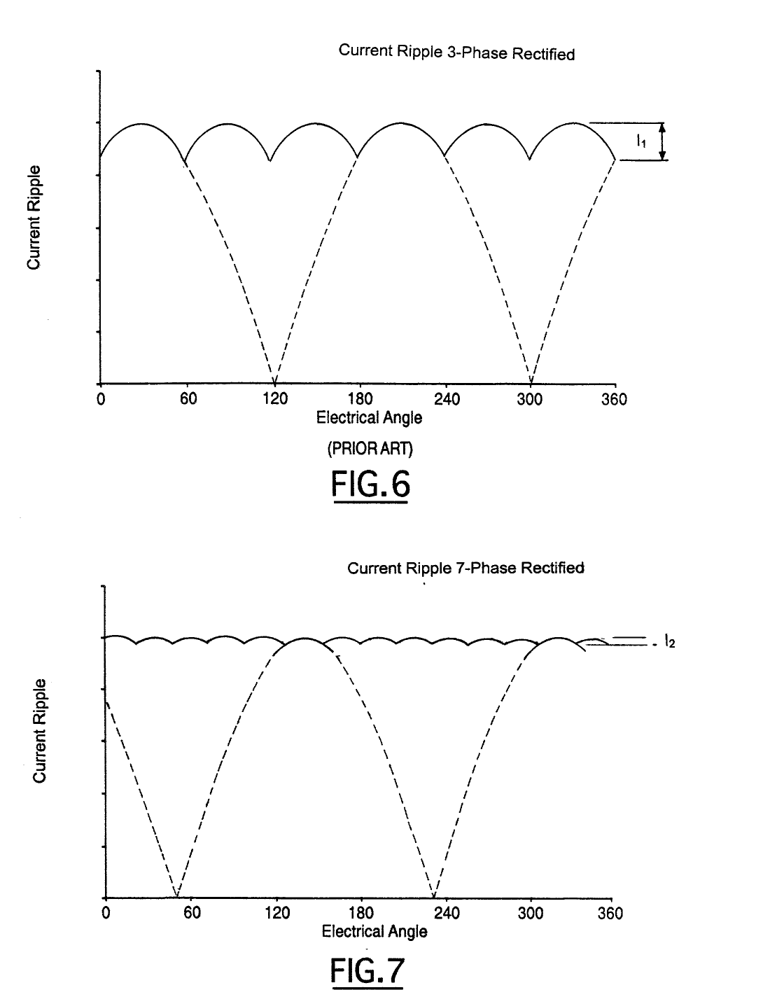

Referring now to FIG. 6, a plot of current ripple versus electrical angle for a three-phase alternator of the prior art is illustrated. The current ripple has a magnitude T₁ that in the prior art corresponds to 0.13 amps.

Referring now to FIG. 7, a seven-phase rectified output of an alternator such as that shown in FIG. 4 is illustrated. In this example, the ripple current T₂ has a peak current of 0.025 amps. As can be seen, this is a substantial reduction from a common three-phase alternator.

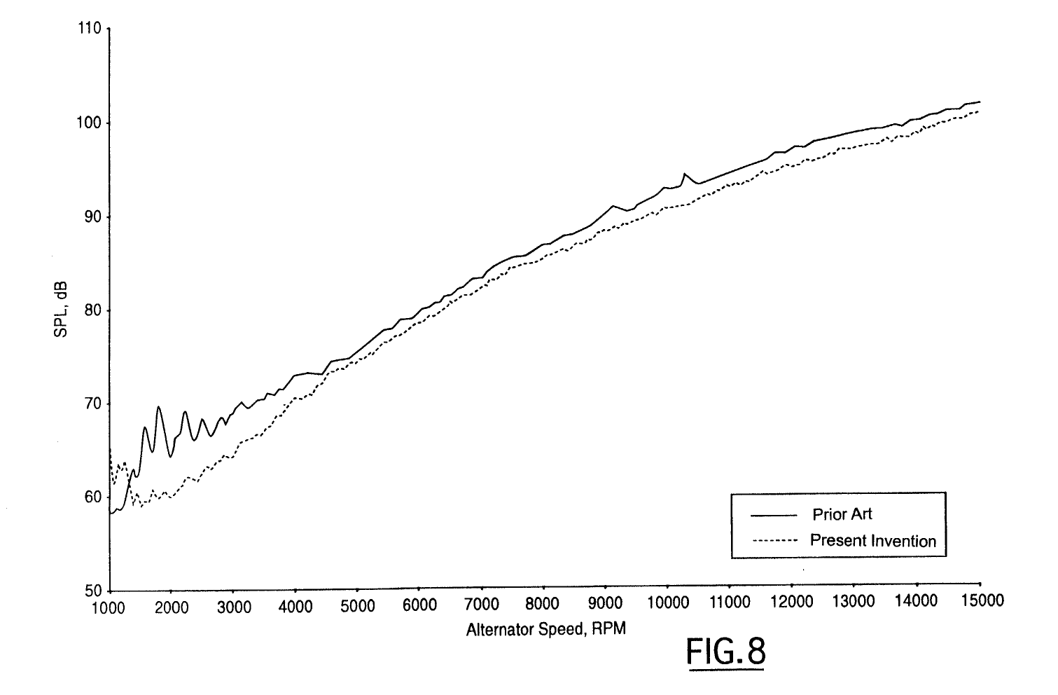

Referring now to FIG. 8, the sound pressure levels of the new winding configuration shown in FIG. 4 are illustrated with respect to an existing winding. As can be seen, the overall sound pressure levels are lower in a winding configuration according to the present invention.

While particular embodiments of the invention have been shown and described, numerous variations and alternate embodiments will occur to those skilled in the art. For examples, although a star and polygon configuration are illustrated, various combinations of the two meeting the 2N+1 criteria may also be formed. Accordingly, it is intended that the invention be limited only in terms of the appended claims.

What is claimed:

1. An electrical machine comprising:
a stator core having slots;
a set of windings disposed within said slots, said set of windings having 2N+1 phases where N is an integer greater than 1.

2. An electrical machine as recited in claim 1 wherein said set of windings is coupled to a common node.

3. An electrical machine as recited in claim 1 wherein said set of windings is coupled polygonally.

4. An electrical machine as recited in claim 1 further comprising a switching circuit coupled to said set of windings, said switching circuit comprising at least 2(2N+1) switching elements.

5. An electrical machine as recited in claim 4 further comprising a full wave rectifier.

6. An electrical machine as recited in claim 1 wherein N=2.

7. An electrical machine as recited in claim 1 wherein N=3.

8. An electrical machine as recited in claim 1 wherein said electrical machine comprises a generator.

9. An electrical machine as recited in claim 1 wherein said set of windings has a full pitch.

10. An electrical machine as recited in claim 1 wherein said set of windings has a fractional pitch.

11. An alternator for an automotive vehicle comprising:
a housing;
a rotor rotatably disposed within said housing;
a stator core disposed within said housing adjacent to said rotor, said stator core having slots; and
a set of windings disposed within said slots, said set of windings having 2N+1 phases where N is an integer greater than 1.

12. An alternator as recited in claim 11 further comprising a full wave rectifier.

13. An alternator as recited in claim 11 wherein said set of windings is coupled to a common node.

14. An alternator as recited in claim 11 wherein said set of windings is coupled schematically in a polygon.

15. An alternator as recited in claim 14 wherein said polygon has 2N+1 sides.

16. An alternator as recited in claim 11 further comprising a rectifier circuit coupled to said first set of windings, said rectifier circuit comprising at least 2(2N+1) rectifying elements.

17. An alternator as recited in claim 11 wherein N=2.

18. An alternator as recited in claim 11 wherein N=3.

19. An alternator for an automotive vehicle comprising:
a housing;
a rotor rotatably disposed within said housing;
a stator core disposed within said housing adjacent to said rotor, said stator core having slots;
a set of windings disposed within said slots, said set of windings having 2N+1 phases where N is an integer greater than 1; and
a full wave rectifier circuit coupled to said set of windings, said rectifier circuit comprising at least 2(2N+1) rectifying elements.

20. An alternator as recited in claim 19 wherein said set of windings is coupled to a common node.

21. An alternator as recited in claim 19 wherein said set of windings is coupled schematically in a polygon.
